(19) United States
(12) Patent Application Publication
(10) Pub. No.: US 2002/0172095 A1
(43) Pub. Date: Nov. 21, 2002

(54) Electric clocks and remote controller

(76) Inventor: Radha K.C. Pandipati, Montgomery Village, MD (US)

Correspondence Address: Radha K.C. Pandipati, Kris Engineering Inc., 19531 Desmet Place, Montgomery Village, MD, 20886, US

(21) Appl. No.: 10/092,655

(22) Filed: Mar. 6, 2002

Related U.S. Application Data
(60) Provisional application No. 60/275,311, filed on Mar. 14, 2001.

(51) Int. Cl. G04C 11/02

(52) U.S. Cl. 368/47

(57) ABSTRACT

This invention relates to setting time on one or more clocks using a remote controller, one at a time. The remote controller synchronizes all the clocks to the same time. The same remote controller can also be used to set alarm on the clocks. The alarm can be set to the same time on all clocks or to a different time on each of the clocks. The clocks referred here contain necessary circuitry to receive the signals from the remote controller to set time or alarm automatically.

### PARENT CASE TEXT

This is a continuation of U.S. Application No. 60/275,311, filed on Mar. 14, 2001, which is a provisional patent application.

### CROSS-REFERENCE TO RELATED APPLICATIONS

| | |
|---|---|
| U.S. Pat. No. 6,157,646 | “Circuit and method for service clock |
| | recovery” by Nichols; Richard Allen, dated |
| | Dec. 5, 2000 |
| U.S. Pat. No. 6,226,368 | “System and method for automatically updating |
| | a clock using caller ID information” by Paul |
| | Teich and David J. Borland, dated May 1, 2001 |
| U.S. Pat. No. 5,671,192 | “Radio-controlled clockwork” by Fritz |
| | Schaffel, dated Sep. 23, 1997 |
| U.S. Pat. No. 5,881,023 | “Self-correcting clock” by Jing-Lu Gu and |
| | Robin Schneyer, dated Mar. 9, 1999 |

### BACKGROUND OF THE INVENTION

1. Field of the Invention

This invention relates to setting time on one or more clocks using a remote controller, one at a time. The remote controller sets all the clocks to the same time and all clocks are synchronized. The clocks referred here contain necessary circuitry to receive the signals from the remote controller to set time.

2. Description of the Related Art

Invariably many homes have a number of clocks, one in the living room, one in each bedroom, one in the basement/recreation room, etc. Similarly, many office buildings have a number of clocks, one in each room and one in each hall-way area. These clocks may be operating using batteries or using household AC electrical power. Whenever there is an interruption of power due to temporary power outages which happen virtually everywhere in the world from time to time, depleted batteries, lightning, or when we move from daylight saving season to non-daylight saving season, one need to correct the time on all clocks. Some times it takes a few days to months before one gets to all of them, because of large effort involved. Even if one corrects the time, invariably it is not easy to set (synchronize) all the clocks to the same time.

Now, with this invention, one can set the time on all the clocks without help from another person in a short period of time. It is also fun to do it. Just set the time on the remote controller, lock it, point the remote controller towards the clock and press the button “sync-time”. That is it. Then go to another room and point the remote controller towards the clock in that room and press the button “sync-time” again. Just repeat this with each clock in the building.

A thorough patent search resulted in the following related patents but none of them teach the idea proposed in this invention. For example, the U.S. Pat. No. 6,157,646 entitled “Circuit and method for service clock recovery” relates to a method for synchronizing a service clock at a destination node with a service clock at a source node for circuit emulation service over a packet network.

The U.S. Pat. No. 6,226,368 entitled “System and method for automatically updating a clock using caller ID information” relates, in general, to a method for automatically updating a clock in a remote device using caller ID information received at a telephony device.

The U.S. Pat. No. 5,671,192 entitled “Radio-controlled Clockwork” relates to Radio-controlled clocks, which are controlled by a control device, receiving the time signals from a radio receiving station.

The U.S. Pat. No. 5,881,023 entitled “Self-correcting clock” generally relates to a clock synchronized by date and time information taken from Caller ID information packets delivered with incoming calls on a telephone line provided with Caller ID service.

There has not been proposed so far a configuration consisting of a remote controller and a clock to receive the signal from remote in order to achieve the easy setting of time on one or multiple number of clocks and synchronize all of the clocks as in the instant invention described here. Thus, none of the above prior art references teach the idea of this invention.

### SUMMARY OF THE INVENTION

This is a continuation of U.S. Application No. 60/275,311, filed on Mar. 14, 2001, which is a provisional patent application. Briefly stated, the instant invention is directed to an apparatus for setting time on one or a number of clocks using a remote controller and thus synchronizing all the clocks.

According to this invention all electrical clocks in a house or an office building come with a unique remote controller. The time can be set easily on the clocks using the remote controller. You need to have only one remote controller for the whole house or office building irrespective of how many clocks it has. These clocks come in various designs, patterns, shapes, colors, and styles (traditional, antique or modem). The remote controller allows you to simply set the time on all clocks. First set the time on the remote controller using the keys/buttons on the controller, and then lock the set time. Now the clock in the remote controller has the time you want all the clocks to be set with. You can point the remote controller towards the clock on the wall and press “sync-time” button. You will see the clock on the wall automatically set to the time shown on your remote controller. Now both the clock on the wall and the clock on the remote controller are running and have same time so when you repeat pressing the “sync-time” button with your next clock, both the first and the second clocks will be showing the same time as the one in the remote controller. Now you can continue this process with all clocks in the building. In a short period of time you can set all clocks in your home or in an office building to the same time easily without taking help from another person. You love to do it yourself.

Similarly, you can set alarm on the remote controller, point towards the clock with alarm and press the “set-alarm” button. That is it. Now the alarm is set. You need only one remote controller for the whole house or office building.

The remote controller has a visual display and a key pad comprising of a number of keys for numerals (0, 1, 2, 3, 4, 5, 6, 7, 8, 9), AM, PM, Enter-Time, Time-Lock, Sync-Time, Enter-Alarm, Set-Alarm, Power-On, Power-Off, Clear, etc. Addition of various other buttons/keys not referred to herein will be obvious to one of ordinary skill in the art upon employment of the invention in practice.

In other words, it is an apparatus for controlling one or a number of clocks remotely, comprising a wireless remote controller, which allows one to initially set time on the remote controller and lock it before transmitting radio-frequency (RF) signals or an infra-red signals to a number of clocks that are controlled by the remote controller; and the clocks, which contain a circuitry to receive the signals transmitted by the remote controller and process the signals to set the clock and alarm time automatically. The controlling function of the apparatus referred above includes a) the control for setting time on all the clocks synchronously, b) the control for setting same alarm time on one or a number of the clocks like in a factory building or in a school building. The circuitry in the clocks can distinguish the time setting signals from the alarm time setting signals. The clocks can be one or more types from the group consisting of wall clocks, radio clocks, television clocks, VCR clocks, DVD clocks, microwave clocks, range clocks, temperature controller clocks and car clocks. The remote controller and the clocks can come in various shapes, colors and styles.

Other and further features of this invention will become obvious upon an understanding of the illustrative embodiments described in the detailed description of the preferred embodiments section. Various advantages not referred to herein will be obvious to one of ordinary skill in the art upon employing the invention in practice.

With respect to the above description then, it is to be realized that the optimum dimensional relationships for the parts of the invention, to include variations in size, materials, shape, form, function and manner of operation, assembly and use, are deemed readily apparent and obvious to one of ordinary skill in the art, and all equivalent relationships to those illustrated in the drawing and described in the specification are intended to be encompassed by the present invention.

Therefore, the foregoing is considered only as an illustrative principle of the invention. Since numerous modifications and changes will readily be apparent to those of ordinary skill in the art, it is not desired to limit the invention to the exact construction and operation shown and described herein, and accordingly, all suitable modifications and equivalents may be resorted to, falling within the scope of the invention.

### BRIEF DESCRIPTION OF THE DRAWINGS

An embodiment of the present invention will be described hereinafter with reference to the accompanying drawings, in which:

FIG. 1: is a schematic block diagram illustrating the overall time/alarm system arrangement comprising a remote controller and the clock. This overall arrangement is a representative embodiment of the present invention.

FIG. 2: illustrates the top plan view of the conceptual remote controller referred in Figure

### DETAILED DESCRIPTION OF THE PREFERRED EMBODIMENT

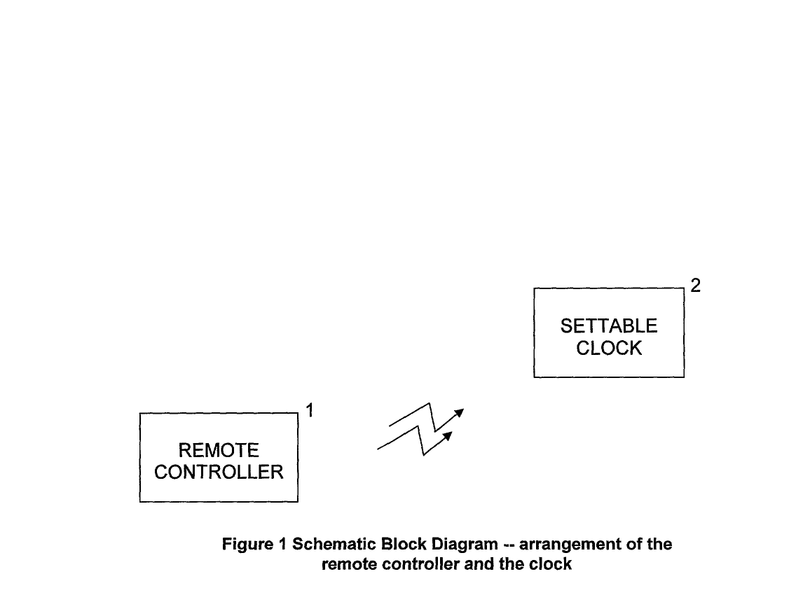

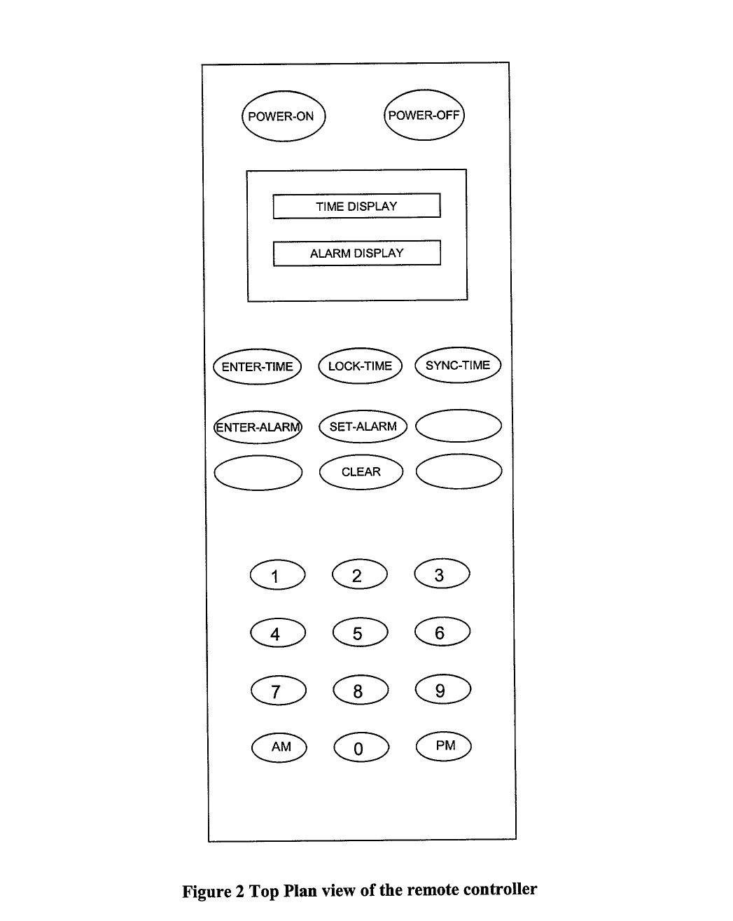

A schematic block diagram is presented in FIG. 1 to illustrate the overall system arrangement of the remote controller 1 and the clock 2. This overall system arrangement is a representative embodiment of the present invention. According to this invention all electrical clocks in a building come with one remote controller 1. FIG. 2 is the top plan view of the remote controller referred in FIG. 1 and is a representative top plan view of the remote controller of the present invention.

As illustrated in FIG. 1, the overall configuration contains the remote controller 1 and the clock 2. The remote controller 1 is hand held and is normally battery operated device which sends control signals wirelessly (using infra-red or radio-frequency) to the clock 2. The top plan view of the remote controller 1 is shown in FIG. 2. The remote controller has a key pad comprising of a number of control keys/buttons for numerals (0, 1, 2, 3, 4, 5, 6, 7, 8, 9), AM, PM, Enter-Time, Time-Lock, Sync-Time, Enter-Alarm, Set-Alarm, Power-On, Power-Off, Clear, etc. Addition of various other buttons/keys not referred to herein will be obvious to one of ordinary skill in the art upon employing the invention to practice. The remote controller 1 also has a display, which enhances the user interface, aiding in initial set-up of clock-time or alarm-time before sending or transmitting “sync-time” or “set-alarm” setup signal to the clock 2. The keypad on the remote controller 1 allows one to set the clock-time and lock it by pressing the “lock time” button on the keypad before transmitting the signal to the clock 2 for setting the time. The keypad on the remote controller 1 also allows one to set the alarm-time before transmitting the signal to the clock 2 for setting the alarm.

The remote controller 1 also contains a built-in clock, whose time is set whenever initial set-up of clock-time is performed on the remote controller 1 using the keypad for the purpose of setting the time on the clocks and locked. From now onwards, the clock in the remote controller 1 maintains the time. This allows the user not to rush or run to all the clocks quickly. For example, you set the time on the remote controller 1, say, to 9:37:30AM and took additional 20 seconds before you aimed the remote controller 1 at your first clock located in the living room wall 8 feet above. Now the clock on the remote controller 1 shows 9:37:50AM and the first clock in the living room gets set to 9:37:50AM. Next you took an additional one minute to go to your master bed room and aim at the clock on the wall. Now the clock in the master bed room gets set to 9:38:50AM. At this time the clock in the living room and the clock in the master bed room and the remote controller 1 all show the same time. Now you can continue this process with all clocks in your home. In just five minutes you can set all clocks in home to the same time easily without seeking the help of another person. You will love to set the clocks yourself. You need to have only one remote controller 1 for the whole house irrespective of how many clocks your house has. The same convenience can be extended to an office building, a school building, or a factory having multiple number of buildings, which may have multiple number of clocks. Just one person can synchronize all clocks in a building or in a multiple number of buildings.

The remote controller 1 also has the provision to initially set-up alarm. You can initially set-up alarm-time on the remote controller 1, aim towards the clock 2 with alarm and press “set-alarm” button to send the signals to the clock 2 to set the alarm on that clock 2.

The clock 2 contains circuitry to receive the signals from the remote controller 1, process them, and set time immediately. The circuitry in the clocks can also distinguish if the received signals are meant for time setting or alarm setting on the clocks. The number of clocks controlled by the remote controller is atleast one.

In other words, it is an apparatus for controlling one or a number of clocks remotely, comprising a wireless remote controller, which allows one to initially set time on the remote controller and lock it before transmitting radio-frequency (RF) signals or infra-red (IR) light signals to a number of clocks that are controlled by the remote controller; and the clocks, which contain a circuitry to receive the signals transmitted by the remote controller and process the signals to set the time automatically. The controlling function of the apparatus referred above includes a) the control for setting time on all the clocks synchronously, b) the control for setting same alarm time on one or a number of the clocks in a home or in a factory building or in a school. The alarm time can be set to different times on different clocks if desired by keep changing the alarm time setting on the remote controller before pressing the “set-alarm” button in front of each clock. The circuitry in the clocks can distinguish the clock time setting signals from the alarm time setting signals.

The remote controller 1 and the clocks 2 come in various designs, patterns, shapes, and colors, traditional, antique or modem styles. The clock 2 referred in this embodiment may take any number of shapes, forms, and embedments. For example, the clock 2 may be a wall clock, a regular desk-top clock, a clock radio, a television, a VCR, DVD, a personal computer, microwave, house temperature controller or some other device that displays the time, which has a built-in remote time/alarm setting facility. Thus, the remote controller 1 can be used to set time on all the equipment/appliances in your home, namely, Microwave, VCR, TV, DVD, house temperature controller or some other devices that display the time.

With respect to the above description then, it is to be realized that the optimum dimensional relationships for the parts of the invention, to include variations in size, materials, shape, form, function and manner of operation, assembly and use, are deemed readily apparent and obvious to one of ordinary skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An apparatus for controlling a number of clocks remotely, comprising:
a wireless remote controller, which allows one to initially set time on the remote controller and lock it before transmitting signals to a number of clocks that are controlled by the remote controller; and
a number of clocks, which contain a circuitry to receive the signals transmitted by the remote controller and process the signals to set the time.

2. An apparatus as recited in claim 1, wherein the number of clocks is at least one.

3. An apparatus as recited in claim 1, wherein the control is meant for setting clock time on all the clocks synchronously.

4. An apparatus as recited in claim 1, wherein the control is meant for setting same alarm time on all the clocks or different alarm time on different clocks.

5. An apparatus as recited in claim 1, wherein the circuitry in the clocks can distinguish the clock time setting signals from the alarm time setting signals.

6. An apparatus as recited in claim 1, wherein the remote control signal is a radio-frequency (RF) signal or an infra-red (IR) light signal.

7. An apparatus as recited in claim 1, wherein the clocks are of one or more types selected from the group consisting of wall clocks, radio clocks, television clocks, VCR clocks, DVD clocks, microwave clocks, range clocks, temperature controller clocks and car clocks.

8. An apparatus as recited in claim 1, wherein the remote controller and the clocks are of various shapes, colors and styles.

9. An apparatus as recited in claim 1, wherein the remote controller has a display and control buttons/keys.

10. An apparatus as recited in claim 9, wherein the control buttons/keys on the remote controller are comprising of numerals (0, 1, 2, 3, 4, 5, 6, 7, 8, 9), AM, PM, Enter-Time, Time-Lock, Sync-Time, Enter-Alarm, Set-Alarm, Power-On, Power-Off, and Clear.
